(19) United States
(12) Patent Application Publication
(10) Pub. No.: US 2025/0134000 A1
(43) Pub. Date: May 1, 2025

(54) COVERS FOR AGRICULTURAL CONCAVES AND GRATES

(71) Applicant: Deere & Company, Moline, IL (US)

(72) Inventors: MANISH SINGH, BOKARO (IN); MICHAEL T. MESCHKE, GENESEO, IL (US); JEFFREY R. WALTER, BETTENDORF, IA (US); BRIAN GORGE, COLONA, IL (US); JASON R. DEHNKE, MILAN, IL (US)

(21) Appl. No.: 18/498,903

(22) Filed: Oct. 31, 2023

(51) Int. Cl. A01F 12/26; A01F 12/28

(52) U.S. Cl. CPC A01F 12/26; A01F 12/28

(57) ABSTRACT

A cover for a threshing concave or separator grate of a crop threshing assembly may include a first body portion. The first body portion may include a leading end, a trailing end opposite the leading end, a first lateral side, and a second lateral side opposite the first lateral side. A first passage may be formed through the leading edge, and the passage may define a first axis that extends laterally between the first lateral side and the second lateral side. A notch may be formed in the first body portion and extend from the trailing edge end towards the leading end.

### FIELD OF THE DISCLOSURE

The present disclosure relates generally to crop processing and, particularly, to crop processing systems provided on an agricultural machine.

### BACKGROUND OF THE DISCLOSURE

Crop processing systems (also referred to as threshing and separation systems) of combine harvesters operate to process incoming crop to remove grain from material other than grain (“MOG”). Generally, crop processing systems include one or more rotors and concaves that cooperate to thresh incoming crop material to remove the grain from the MOG. The threshing and separation systems may also include separation grates that operate to release the separated grain from the MOG where the released grain is subsequently processed to further clean the released grain.

### SUMMARY OF THE DISCLOSURE

A first aspect of the present disclosure is directed to a cover for a threshing concave or separator grate of a crop threshing assembly. The cover may include a first body portion. The first body portion may include a leading end, a trailing end opposite the leading end, a first lateral side, and a second lateral side opposite the first lateral side. The cover may also include a first passage formed through the leading edge. The passage may define a first axis that extends laterally between the first lateral side and the second lateral side. The cover may also include a notch formed in the first body portion and extending from the trailing end towards the leading end.

Another aspect of the present disclosure is directed to a crop processing apparatus in a threshing assembly of an agricultural machine. The crop processing apparatus may include a frame including a first frame rail and a second frame rail offset from the first frame rail; a shaft extending between the first frame rail and the second frame rail; and a cover extending between the first frame rail and the second frame rail. The cover may include a first body including a leading end, a trailing end opposite the leading end, a first lateral side, and a second lateral side opposite the first lateral side. The cover may also include a first passage formed along the leading end and a notch formed in the first body portion and extending from the trailing end towards the leading end. The opening may define a first axis that extends laterally between the first lateral side and the second lateral side, and the shaft may be disposed in the first passage. The cover may be pivotably movable on the shaft about the first axis.

The various aspects may include one or more of the following features. The notch may be a V-shaped. The notch may include a plurality of notches formed in the first body portion. The plurality of notches may be uniformly distributed along the trailing edge. A bushing may be disposed in the first passage. A first raised portion may be formed on the first body portion, and a first bore may extend through the first raised portion. The first bore may define a second axis extending laterally. A bushing may be disposed in the first bore. The first raised portion may be laterally positioned at a central location along the body. The first raised portion may be positioned adjacent to one of the first lateral side and the second lateral side. A second raised portion may be included, and a second bore may extend through the first raised portion. The second bore may be aligned with the first bore. The first raised portion may be positioned at a location adjacent to the first lateral side, and the second raised portion may be positioned at a location adjacent to the second lateral side. The cover may include a second body portion, and the second body portion may be joined with the first body portion at the leading edge. The second body portion may include a distal end defining a second passage defining a second axis that extends laterally. The first body portion and the second body portion may be flexibly coupled to define a living hinge.

The various aspects may include one or more of the following features. The shaft may extend through an opening formed in the bushing. A linkage may be pivotably connected to the cover, and the cover may be pivotable about the first axis in response to movement of the linkage. The linkage may be pivotably connected to the cover via a second shaft disposed in the first bore. The second shaft may extend through an opening formed in the bushing. The linkage may include a spine and at least one finger extending from the spine. The at least on finger may be connected to the cover. The at least one finger may include a compliance portion having an S-shape.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 a diagrammatic side view of an agricultural machine configured to harvest and process crop, according to some implementations of the present disclosure.

FIG. 2 is an oblique view of a grate assembly, according to some implementations of the present disclosure.

FIG. 3 is an oblique view of an example cover of a grate assembly, according to some implementations of the present disclosure.

FIG. 4 is an oblique view of another example cover, according to some implementations of the present disclosure.

FIG. 5 is a detail view of the example cover illustrating the bushings included therewith, according to some implementations of the present disclosure.

FIGS. 6 through 8 are oblique view of additional example covers, according to some implementations of the present disclosure.

FIG. 9 is a detailed oblique view of an example grate assembly that includes a linkage with fingers having compliant portions, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

The present disclosure is directed to crop processing systems of agricultural machines, such as crop processing systems on combine harvesters. The crop processing systems include threshing and separation systems that operate to release and separate grain from MOG. The threshing and separation systems include a rotatable rotor and one or more concaves and one or more separation grates that cooperate with the rotor to thresh and separate incoming crop material. The concaves and separator grates can include movable covers that operate to control a size of openings exposed to the concaves and separator grates and, thus, control a rate of material permitted through the covers and an amount of air flow introduced to the crop being processed by the rotor, concaves, and separator grates.

The covers are movable to different positions to alter a flow of crop material from the threshing and processing system and alter air flow to the crop being processed. However, an object, such as crop material, sticks, rocks, or other debris, may become lodged in the threshing and processing system at a location that may interfere with one or more of the covers. For example, the lodged object may cause damage to the cover when a position of the cover is altered. For example, the lodged object may cause the cover to bend (e.g., yield), crack, break, or otherwise become damaged due to interference with the object when the cover is moved to a closed position. A damaged cover increases costs, such as costs associated with replacement costs, labor costs needed to replace the damaged cover, and costs associated with lost harvesting production.

The present disclosures provides numerous improvements to grate assemblies, including concave and separator grate covers, which are described in more detail below. As a result, compliance of the covers is increased, allowing the covers to deform elastically, thereby avoiding damage to the covers.

Words of orientation, such as “up,” “down,” “top,” “bottom,” “above,” “below,” “leading,” “trailing,” “front,” “back,” “forward,” and “rearward” are used in the context of the illustrated examples as would be understood by one skilled in the art and are not intended to be limiting to the disclosure. For example, for a particular type of vehicle in a conventional configuration and orientation, one skilled in the art would understand these terms as the terms apply to the particular vehicle.

For example, the term “forward” (and the like) corresponds to a forward direction of travel of an agricultural machine, e.g., a head or combine harvester, such as during a harvesting operation. Likewise, the term “rearward” (and the like) corresponds to a direction opposite the forward direction of travel. In this regard, for example, a “forward facing” feature on a head may generally face in the direction that the head travels during normal operation, while a “rearward facing” feature may generally face opposite that direction.

Also as used herein, with respect to an agricultural machine (or components thereof), unless otherwise defined or limited, the term “leading” (and the like) indicates a direction of travel of the agricultural machine during normal operation (e.g., the forward direction of travel of a harvester vehicle carrying a head). Similarly, the term “trailing” (and the like) indicates a direction that is opposite the leading direction.

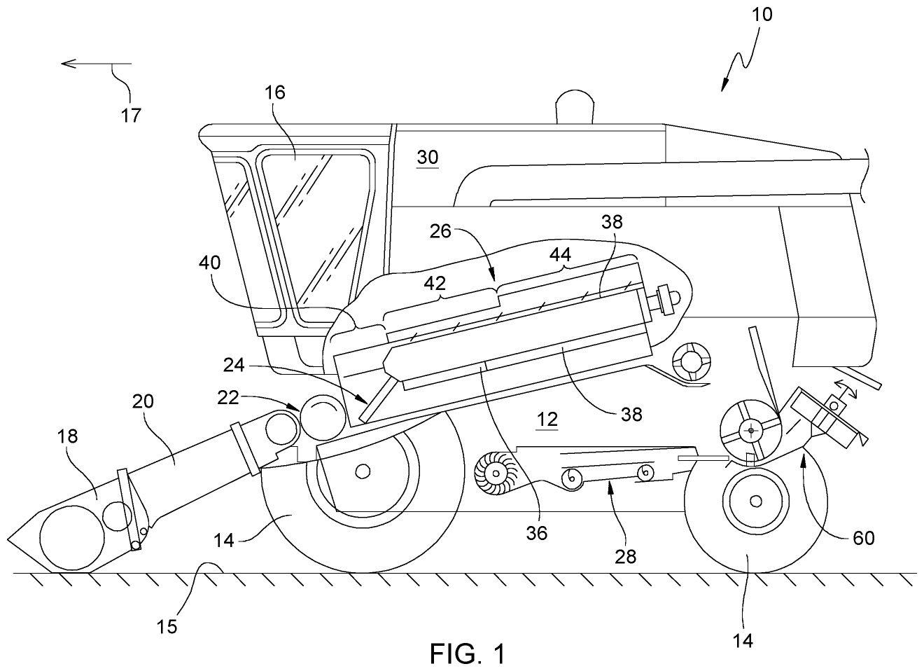

FIG. 1 is a diagrammatic side view of an example agricultural machine 10. In the illustrated example, the agricultural machine 10 is a combine harvester. However, the scope of the disclose encompasses other types of agricultural machines that include a threshing assembly, described in more detail below. The agricultural machine 10 includes a frame 12 and one or more ground engaging mechanisms, such as wheels 14 or tracks, that are in contact with an underlying ground surface 15. In the illustrative implementation, the wheels 14 are coupled to the frame 12 and are used to transport the agricultural machine 10 across the ground surface 15, such as in a forward operating direction, as indicated by arrow 17. In some implementations, operation of the agricultural machine 10 is controlled from an operator's cab 16. The operator's cab 16 may include any number of controls for controlling the operation of the agricultural machine 10, including, for example, a user interface. In some implementations, operation of the agricultural machine 10 may be conducted by a human operator in the operator's cab 16, a remote human operator, or an automated system.

A cutting head 18 is disposed at a forward end of the agricultural machine 10 and is used to harvest crop and to conduct harvested crop material to a feederhouse 20 of the agricultural machine 10. The term harvested crop material, as used herein, includes grain (e.g., corn, wheat, soybeans, rice, oats) and material other than grain (MOG). The feederhouse 20 includes a conveyor that conducts the harvested crop to a guide drum 22. The guide drum 22 rotates relative to the frame 12 to move the harvested crop below the guide drum 22 to an inlet 24 of a threshing assembly 26, as shown in FIG. 1. In some implementations, the threshing assembly 26 is a dual rotor threshing assembly. However, the scope of the disclosure encompasses other types of threshing assemblies, including, for example, a single rotor threshing assembly. The threshing assembly 26 includes a threshing rotor 35, a concave 36, and a separation grate 38. The concave 36 and separation grate 38 are adjacent to the threshing rotor 35 and conform to a circumferential shape of the threshing rotor 35. A gap formed between the threshing rotor 35 and at least one of the concave 36 and separation grate 38 is adjustable to alter a processing of the harvested crop material.

The threshing assembly 26 includes a charging section 40, a threshing section 42, and a separating section 44. The charging section 40 is arranged at a forward or front end of the threshing assembly 26; the separating section 44 is arranged at a trailing or rear end of the threshing assembly 26; and the threshing section 42 is arranged between the charging section 40 and the separating section 44. The concave 36 is located at the threshing section 42, and the separation grate 38 is located at the separating section 42.

The concave 36 cooperates with the threshing rotor 35 to process harvested crop, for example, by compressing the harvested crop to remove grain from MOG before the harvested crop is moved to the separating section 44. The separation grate 38 is positioned in the separating section 44 and cooperates with the threshing rotor 35 to process harvested crop, for example, to release the grain from MOG. Each of the concave 36 and the separation grate 38 includes a plurality of openings, and the separated grain falls through the plurality of openings formed in the concave 36 and the separation grate 38.

The agricultural machine 10 also includes a cleaning assembly 28 that cleans the grain from other material the falls through the concave 36 and separation grate 38. The clean grain is transported to a grain tank 30 for storage, and the MOG from the cleaning assembly 28 and the threshing assembly 26 is directed to residue system 60. In some implementations, the residue system 60 includes a chopper 62 that operates to chop the MOG into smaller pieces that are subsequently expelled from the agricultural machine 10.

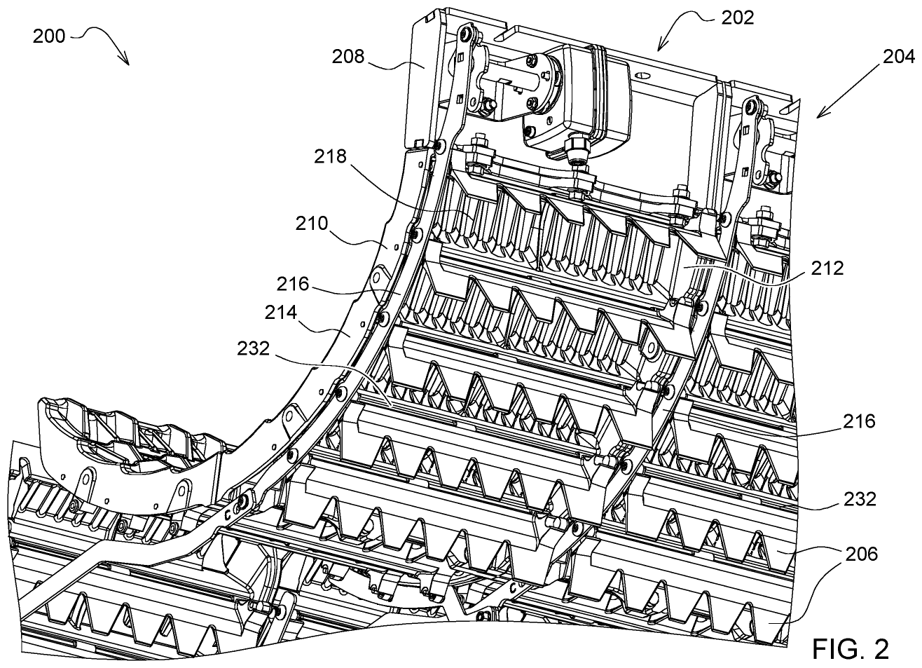

FIG. 2 is an oblique view of a grate assembly 200. The grate assembly includes threshing portion or a concave (referred to hereinafter as threshing portion 202) and a separation portion or separation grate (referred to hereinafter as separation portion 204). The threshing portion 202 includes a plurality of covers or flaps (referred to hereinafter as covers 206). Although the separation portion 204 is shown as lacking covers 206, in other implementations, the separation portion 204 also includes a plurality of covers 206.

The grate assembly 200 includes a frame 208 that includes a first frame rail 210 and a second frame rail 212. The present example frame 208 includes other frame rails that are not illustrated. Thus, in some instances, the frame 208 may include additional frame rails than those illustrated in the example of FIG. 2. The frame 208 of the grate assemblies 200 may have a different construction and may include, for example, additional or fewer frame rails that the illustrated example of FIG. 2.

The covers 206 are pivotably connected to the threshing portion 202 and the separation portion 204. In the illustrated example, the covers 206 of the threshing portion 202 are connected via a linkage 216 such that movement of the linkage 216 causes simultaneous rotation of the interconnected covers 206. Similarly, the covers 206 of the separation portion 204 are connected via a linkage 216 such that movement of the linkage 216 causes simultaneous rotation of the interconnected covers 206. The covers 206 are movable to expose and to cover openings 218 formed in threshing portion 202 (or, in the context of the separation portion 204, openings formed therein) to control material flow from a threshing assembly, such as threshing assembly 26, described earlier, and to control air flow through the threshing portion 202. In some implementations, each of the linkages 216 is movable in response to actuation of an actuator. Consequently, the covers 206 are movable between a fully closed condition and a fully open condition in response to operation of the actuator and the linkage 216.

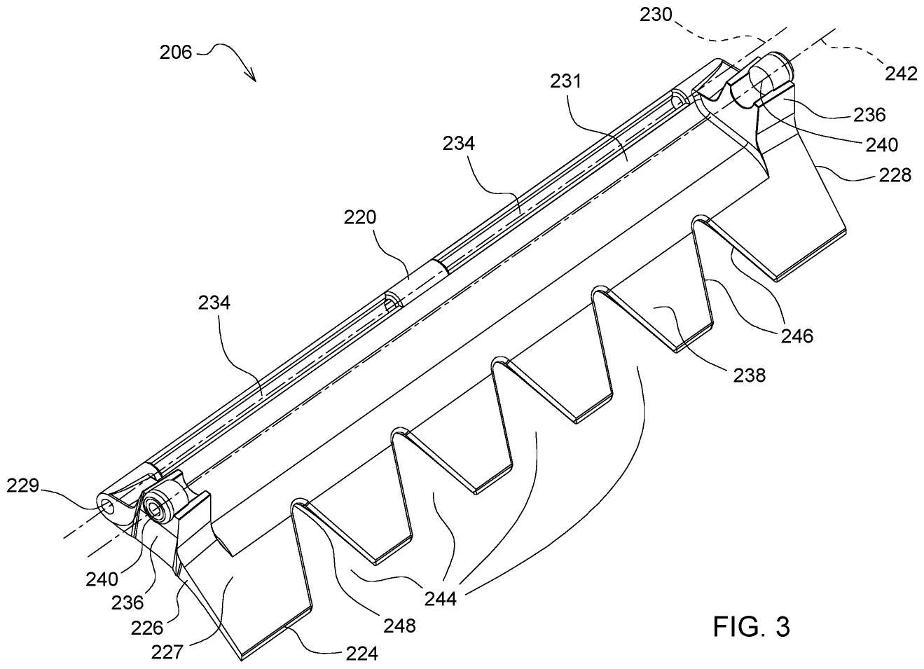

FIG. 3 is an oblique view of one of the covers 206. The cover 206 includes a leading end 220; a trailing end 224 opposite the leading end 220; a first lateral side 226; and a second lateral side 228, opposite the first lateral side 226. The cover 206 forms a curved shape that allows the cover 206 to conform to the generally circular shape of a grate assembly, such as grate assembly 200. For example, in the example shown in FIG. 3, the cover includes an aft portion 227 that is angles relative to a leading portion 231. In other implementations, the cover 206 may have a planar shape. A passage 228 extends laterally through the leading end 220 and defines an axis 230. A shaft 232, shown in FIG. 2, is received into the passage 228 and pivotably connects the cover 206 to the grate assembly 200, such as to the threshing portion 202 or the separation portion 204. In some implementations, the shaft 232 is received into openings formed in the frame rails, such as frame rails 210 and 212, as shown in FIG. 2. For example, the shaft may be received into openings formed in adjacent frame rails of the grate assembly 200. In some implementations, the cover 206 is formed from a polymeric material, such as a flexible polymeric material. In other implementations, the cover 206 is formed from a metal.

When attached to a grate assembly, such as grate assembly 200, the cover 206 is pivotable about the axis 230. For a threshing assembly, such as threshing assembly 26, that includes a longitudinally oriented threshing rotor, the axis 230 about which the cover 206 pivots, when installed on a grate assembly of the threshing assembly, is generally longitudinally oriented. In some instances, the axis 230 is arranged longitudinally along an agricultural machine, such as agricultural machine 10, and has an inclined orientation from front to rear or a declined orientation from front to rear of the agricultural machine when the agricultural machine is positioned on level ground.

Referring again to FIG. 3, the cover 206 also includes one or more openings 234 extending between an exterior of the cover 206 and the passage 229. Thus, the openings 234 provide fluid communication between an exterior of the cover 206 and the passage 229. The example cover 206 shown in FIG. 2 includes two openings 234. However, in other implementations, the cover 206 may include additional or fewer openings. In still other implementations, the cover 206 may omits the openings 234.

The cover 206 also includes raised portions 236. In the illustrated example, the raised portions 236 are formed on a side 238 of the cover 206 formed between the first and second lateral sides 226, 228. Although the example cover 206 includes two raised portions 236, in other implementations, the cover 206 may include additional or fewer raised portions. For example, in some implementations, the cover 206 may include a single raised portion 236. Further, the single raised portion 236 may be positioned centrally between the first and second lateral sides 226, 228. In other implementations, a raised portion 236 may be positioned off center on side 238 between the first and second lateral sides 226, 228. For example, in some instances, the cover 206 may include a single raised portion 236 positioned at the first lateral side 226 or the second lateral side 228.

A bore 240 is formed in each of the raised portions 236. The bores 240 formed in the raised portions 236 are aligned to define an axis 242. In some implementations, the axis 242 is parallel to the axis 230. The bores 240 provide for connecting the cover 206 with the linkage 216, as shown in FIG. 2. In the example illustrated in FIG. 2, the linkage 216 is connected at one of the raised portions 236 on each of the covers 206 while the other raised portion 236 is not connected to a linkage. Thus, in some implementations, the unconnected raised portion 236 may be omitted. The linkage 216 is connected to the raised portion 236 such as with a fastener, shaft, or other component received passing through or connected to the linkage 216 and received into the bore 240 of the raised portion 236. The connection between the raised portion 236 and the linkage 216 allows for pivoting movement of the cover 206 relative to the linkage 216 as the linkage 216 moves to pivot the cover 206 about the axis 230.

Referring again to FIG. 3, the cover also includes a plurality of notches 244 formed in the trailing end 224 of the cover 206. The notches 244 provide or improve the ability of the cover 206 to elastically deform, thereby avoiding or reducing the risk of damage to the cover 206. For example, if a piece of crop material or other debris ingested by a threshing assembly, such as threshing assembly 26, becomes lodged and extends outwardly from a grate assembly, such as grate assembly 200, and between adjacent covers 206, the one or more notches 244 allows the cover 206 to distort when the cover 206 is moved into the closed position. When the cover 206 is moved to a non-closed position, the cover 206 returns to its original shape. As a result, compliance of the cover 206 is improved and the risk of damage to the cover 206 when encountering a piece of lodge material is eliminated or reduced. The notches provide stress relieve and permit the cover 206 to deform, such as to conform, at least partly, to the object obstructing movement of the cover 206.

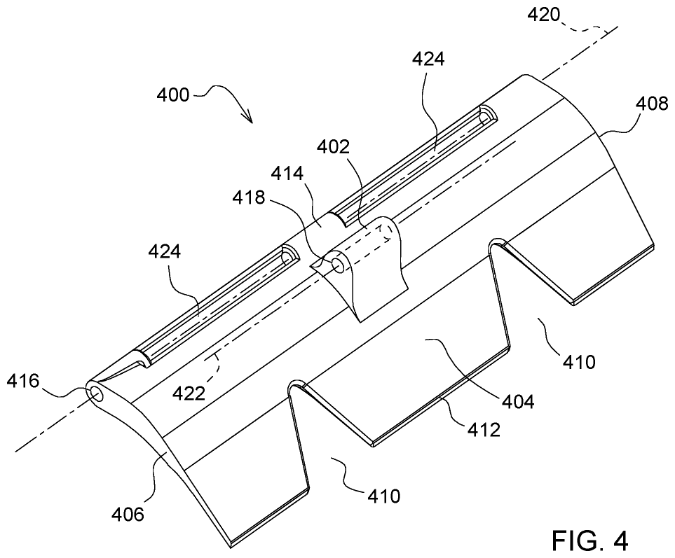

Although five notches 244 are shown in the example of FIG. 3, a cove within the scope of the present disclosure may include additional or fewer notches 244. For example, for a cover 400, as shown in FIG. 4, includes a raised portion 402 centered on side 404 between first and second lateral sides 406 and 408, and two notches 410 are formed in a trailing end 412 of the cover 400. The cover 400 may otherwise be similar to cover 206, except as where described. Also, a leading end 414 includes a passage 416, similar to passage 229, extending between the lateral sides 406 and 408. A bore 418, similar to bore 240, is formed in the raised portion 402. In some implementations, axes 420 and 422 defined by the passage 416 and bore 418, respectively, are parallel to each other. The cover 400 also includes openings 424, similar to openings 234, formed in the leading end 414. The openings 424 provide communication between the passage 416 and an exterior of the cover 400.

The notches 244 have a generally triangular shape with sides 246 meeting at an edge 248. However, the notches 244 may have other shapes. For example, one or more of the notches 244 on a cover 206 may have a generally triangular shape, but one or both of the sides 246 may be curved. Other shapes are also within the scope of the present disclosure.

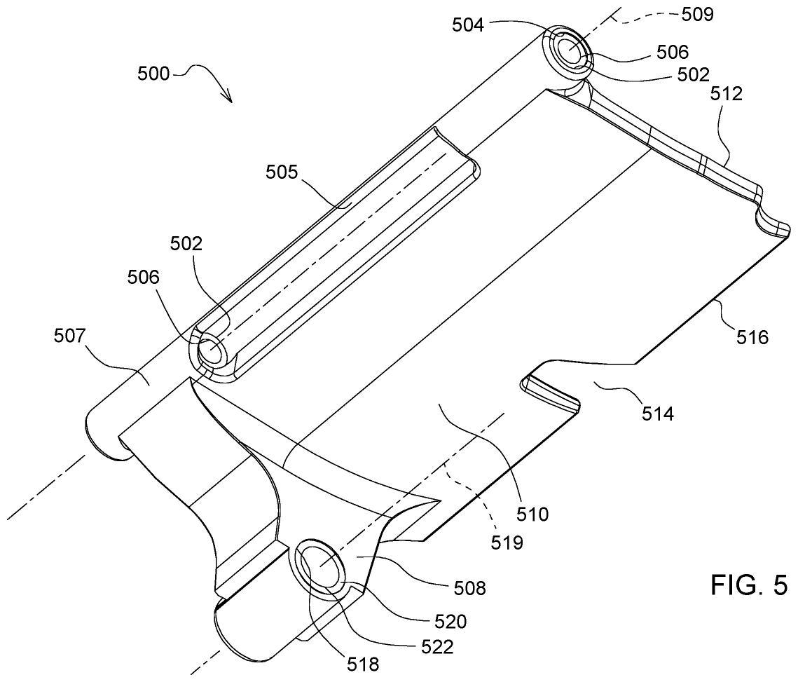

Additionally, in some implementations, to improve compliance of the covers, that is, to promote flexing of the cover as opposed to breaking (such as by cracking), the cover 500 includes one or more bushings, as shown in FIG. 5. FIG. 5 is an oblique view of another example cover 500, which may be similar to cover 400. The cover 500 includes bushings 502 included in the passage 504, which may be similar to passage 229. The passage 504 defines an axis 509, similar to axis 230. An opening 505, similar to opening 234, is formed in a leading end 507 of the cover 500. The bushings 502 are flexible and define openings 506. A shaft, similar to shaft 232, described above, extends through the openings 502 formed in the bushings 500. As a result of the flexibility of the bushings 502, distortion of the cover 500, such as in response to encountering a lodged object in a grate assembly (such as grate assembly 200), damage to the cover 500 is avoided or reduced. In some implementations, the bushings 502 are formed from a polymeric material, such as rubber.

As also shown in FIG. 5, the cover 500 includes a raised portion 508, which may be similar to raised portion 236, except that the raised portion 508 is positioned centrally on surface 510 between a first lateral side 512 and a second lateral side, not illustrated. A notch 514 is formed in a trailing end 516 of the cover 500 between the raised portion 508 and each of the lateral sides of the cover 500. The notches 514 perform similar to the notches 244, described earlier.

A bore 518 is formed in the raised portion 508. The bore 518 defines an axis 519, similar to axis 242. In some implementations, the axes 509 and 519 are parallel. The bore 518 is used to connect the cover 500 to a linkage, as described above. Here, the bore 518 includes a bushing 520 that defines an opening 522. A fastener, shaft, pin, or other component joining the linkage to the cover 500 passes through the opening 522 of the bushing 520. The bushing 520 performs in a manner similar to that of bushings 502, providing additional compliance (e.g., flexibility) when the cover 500 encounters an object, such as when the cover 500 is being moved from one position to another by movement of the linkage. Similar to the bushings 502, the bushing 520 may be formed of a flexible polymer, such as a rubber.

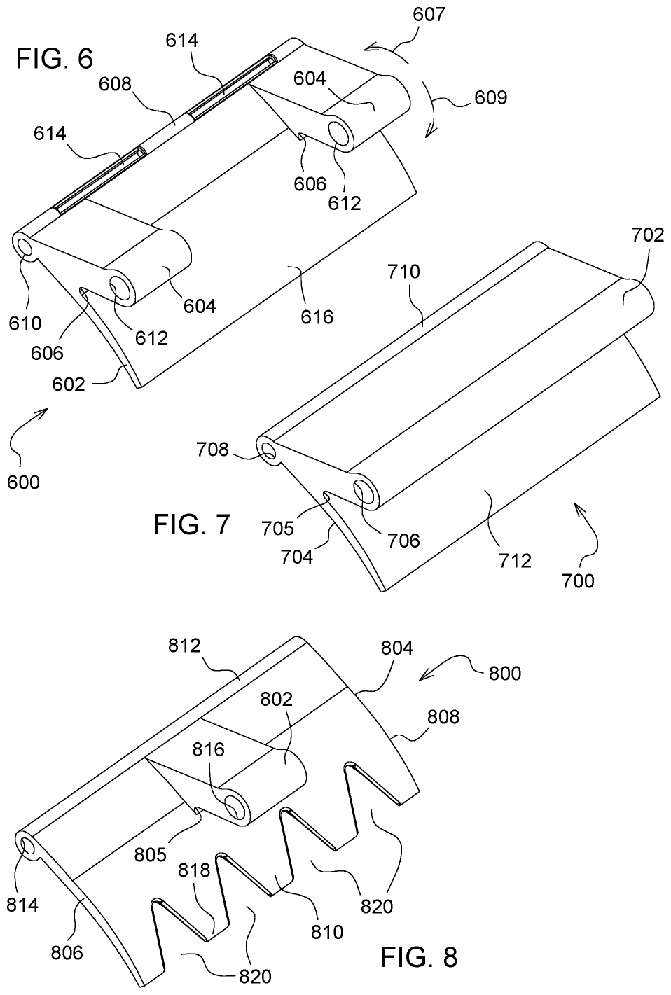

FIG. 6 is another example cover 600 that includes a portion body portion 602 and a second body portion 604 extending from the first body portion 602. In the illustrated example of FIG. 6, there are two second body portions 604. However, in some implementations, one of the second body portions 604 may be omitted. The first and second body portions 602 and 604 form a living hinge 606 that further increases the flexibility and compliance of the cover 600. For example, when the cover 600 encounters an object, such as an object lodged in a grate assembly, such as grate assembly 200, the first body portion 602 flexes relative to the second body portion 604 at the living hinge 606. As a result, the risk of damage to the cover 600 is avoided or reduced.

In some implementations, the second body portions 604 are integrally formed with the first body portion 602. In some instances, the cover 600 is formed from a flexible material, such as a flexible polymeric material. Thus, the second body portions 604 are pivotable via the living hinge 606 in the directions of arrows 607 and 609.

A leading end 608 of the cover 600 includes a passage 610, similar to passage 229, that receives a shaft, similar to shaft 232, to couple the cover 600 to a grate assembly, such as grate assembly 200. The cover 600 is pivotable on the shaft. The second body portion 604 includes a bore 612. The second body portion 604 connects the cover 600 to a linkage, such as linkage 216, to alter a position of the cover on the grate assembly. In a manner similar to that described earlier, the bore 612 receives a fastener, shaft, pin, or other component to secure the linkage and the cover 600 together. The cover 600 also includes openings 614 similar to the openings 234, that provide communication between the passage 610 and the exterior of the cover 600. In some implementations, the openings 614 may be omitted. Further, although not illustrated, the cover 600 may also include one or more notches, similar to notches 244, formed in a trailing end 616 of the cover 600.

FIG. 7 is an oblique view of another example cover 700, similar to cover 600, except that a second body portion 702 of the cover 700 extends along an entirety of a first body portion 704 of the cover 700. A living hinge 705 is formed by the first body portion 704 and the second body portion 702. The living hinge 705 may be similar to the living hinge 606. In other implementations, the second body portion 702 may extend across the first body portion 704 less than an entirety of the first body portion 704. The second body portion 702 includes a bore 706 and functions in a manner similarly to that of the second body portion 604 and bore 612, respectively. The cover 700 also includes a passage 708 formed in a leading end 710 of the cover 700. The passage 708 functions in manner similar to that of passage 610 described earlier. In some implementations, the cover 700 may include one or more notches, which may be similar to notch 244, formed in a trailing end 712 of the cover 700.

FIG. 8 is an oblique view of another example cover 800, similar to cover 600, except that the cover 800 includes a single second body portion 802 connected to a first body portion 804. The first body portion 804 and the second body portion 802 form a living hinge 805, similar to those described above. In some implementations, the first and second body portions 804 and 802 are integrally formed together. In the illustrated example, the second body portion 802 is centrally located between first and second lateral sides 806 and 808. In other implementations, the second body portion 802 may be positioned at other locations along the side 810. A leading end 812 of the cover 800 includes a passage 814, similar to passage 610 or 708. The second body portion 802 includes a bore 816, which may be similar to bores 612 and 706. Additionally, a trailing end 818 includes a plurality of notches 820. The example cover 800 includes four notches 820. In other implementations, additional or fewer notches 820 may be included.

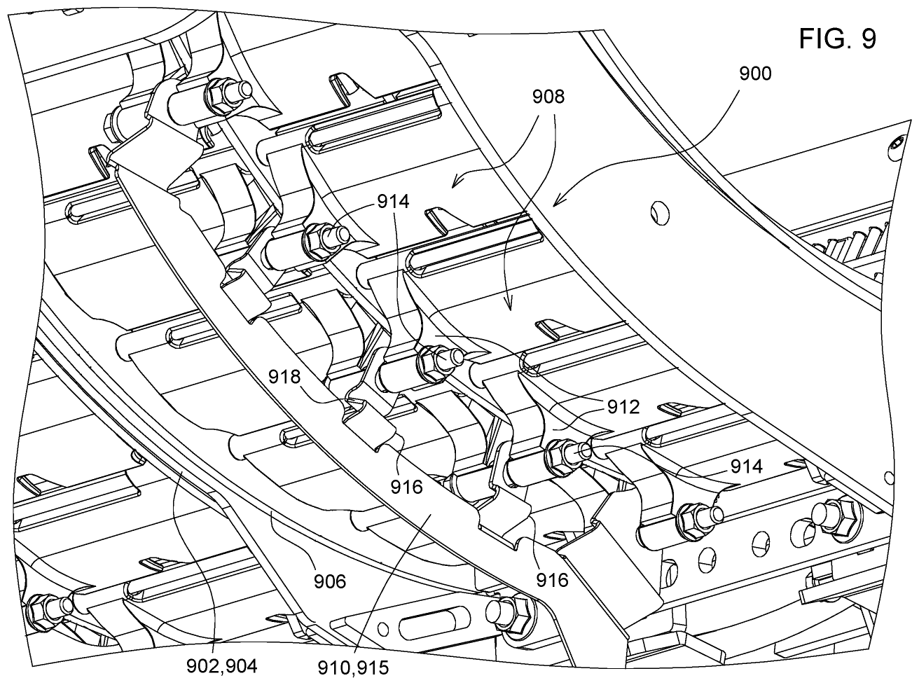

FIG. 9 is a detail view of another grate assembly 900 that includes a frame 902 having a frame rail 904. The grate assembly 900 includes a threshing portion 906 that includes a plurality of covers 908 pivotably connected to the frame 902. As shown, a group of the covers 908 are connected to a linkage 910 that is operable to collectively move the connected cover 908 in unison when the linkage 910 is moved, such as by an actuator. The covers 908 may be similar to the cover 500 and includes a raised portion 912 that functions to connect the cover 908 to the linkage 910. Similar to the other raised portions described herein, the raised portion 912 includes a bore that receives a fastener 914 used to connect the linkage 910 to the cover 908. Although a fastener 914 (e.g., a bolt and nut combination) is illustrated, in other implementations. Other types of components may be used, such as a pin or shaft.

The linkage 910 includes a spine 915 with a plurality of fingers 916 extending from the spine 915. In the illustrated example, each finger 916 connects the linkage 910 to a respective cover 908. The fingers 916 include a compliant portion 918 having a curved shape. For example, in some instances, the compliant portion 918 includes a corrugated or undulating shape, e.g., an S-shape. The undulating shape of the compliant portion 918 defines a spring that allows the finger 916 to deform elastically, such as when a cover 908 is, for example, unable to move into a fully closed position, such as due to the presence of an obstruction. The compliance portion 918 flexes, such as by compression, when a cover 908 is unable to move fully into a position in response to movement of the linkage 910. Because flexing, e.g., compression, of the compliance portion 918 is elastic, when the linkage 910 is moved such that an obstruction no longer prevents a cover 908 from moving with the linkage 910, the compliance portion 918 returns to its original shape. As a result, the linkage 910 provides additional compliance.

One or more of the compliance features described herein are combinable to provide for compliance, e.g., flexing, at different locations of a grate assembly. Consequently, by combining features in this way, the risk of damage to one or more components of a grate assembly is avoided or reduced. Consequently, uptime of an agricultural machine including these features, such as a combine harvester, increases and the cost of repairs is decreases. As a result of improved uptime of an agricultural machine, time to complete a field operation, such as a harvesting operation, is reduced, thereby reducing production costs.

Without in any way limiting the scope, interpretation, or application of the claims appearing below, a technical effect of one or more of the example implementations disclosed herein is a reduced risk of damage to one or more components of a grate assembly. Another technical effect of one or more of the example implementations disclosed herein is increased operational efficiency of an agricultural machine due to a reduction in machine inoperability due to damage to a grate assembly or threshing assembly. Another technical effect of one or more of the example implementations disclosed herein is a reduction in repair costs associated with damage to a grate assembly due to interference between a cover and a lodged object.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. A cover for a threshing concave or separator grate of a crop threshing assembly, the cover comprising:
a first body portion including:
a leading end;
a trailing end opposite the leading end;
a first lateral side; and
a second lateral side opposite the first lateral side;
a first passage formed through the leading edge, the passage defining a first axis that extends laterally between the first lateral side and the second lateral side; and
a notch formed in the first body portion and extending from the trailing end towards the leading end.

2. The cover of claim 1, wherein the notch is V-shaped.

3. The cover of claim 1, wherein the notch comprises a plurality of notches formed in the first body portion.

4. The cover of claim 3, wherein the plurality of notches are uniformly distributed along the trailing edge.

5. The cover of claim 1, further comprising a bushing disposed in the first passage.

6. The cover of claim 1, further comprising:
a first raised portion formed on the first body portion; and
a first bore extending through the first raised portion, the first bore defining a second axis extending laterally.

7. The cover of claim 6, further comprising a bushing disposed in the first bore.

8. The cover of claim 6, wherein the first raised portion is laterally positioned at a central location along the body.

9. The cover of claim 6, wherein the first raised portion is positioned adjacent to one of the first lateral side and the second lateral side.

10. The cover of claim 6, further comprising:
a second raised portion; and
a second bore extending through the first raised portion, the second bore aligned with the first bore,
wherein the first raised portion is positioned at a location adjacent to the first lateral side, and
wherein the second raised portion is positioned at a location adjacent to the second lateral side.

11. The cover of claim 1, further comprising a second body portion, the second body portion joined with the first body portion at the leading edge, the second body portion including:
a distal end defining a second passage defining a second axis that extends laterally,
wherein the first body portion and the second body portion are flexibly coupled to define a living hinge.

12. A crop processing apparatus in a threshing assembly of an agricultural machine, the crop processing apparatus comprising:
a frame including:
a first frame rail; and
a second frame rail offset from the first frame rail;
a shaft extending between the first frame rail and the second frame rail; and
a cover extending between the first frame rail and the second frame rail, the cover including:
a first body portion including:
a leading end;
a trailing end opposite the leading end;
a first lateral side; and
a second lateral side opposite the first lateral side;
a first passage formed along the leading end, the opening defining a first axis that extends laterally between the first lateral side and the second lateral side, the shaft disposed in the first passage, the cover pivotably movable on the shaft about the first axis; and
a notch formed in the first body portion and extending from the trailing end towards the leading end.

13. The crop processing apparatus of claim 12, wherein the notch is V-shaped.

14. The crop processing apparatus of claim 12, wherein the notch comprises a plurality of notches formed in the first body portion.

15. The crop processing apparatus of claim 14, wherein the plurality of notches are uniformly distributed along the trailing end.

16. The crop processing apparatus of claim 12, further comprising a bushing disposed in the first passage, wherein the shaft extends through an opening formed in the bushing.

17. The crop processing apparatus of claim 12, further comprising a linkage pivotably connected to the cover, the cover pivotable about the first axis in response to movement of the linkage.

18. The crop processing apparatus of claim 17, wherein the cover further includes:
a first raised portion formed on the first body portion; and
a first bore extending through the first raised portion, the first bore defining a second axis extending laterally,
wherein the linkage is pivotably connected to the cover via a second shaft disposed in the first bore.

19. The crop processing apparatus of claim 18, further comprising a bushing disposed in the first bore, and
wherein the second shaft extends through an opening formed in the bushing.

20. The crop processing apparatus of claim 12, wherein the cover further includes a second body portion, the second body portion joined with the first body portion at the leading end, the second body portion including:
a distal end defining a second passage defining a second axis that extends laterally,
wherein the first body portion and the second body portion are flexibly coupled to define a living hinge.

21. The crop processing apparatus of claim 12, wherein the linkage comprises:
a spine; and
at least one finger extending from the spine, the at least on finger connected to the cover.

22. The crop processing apparatus of claim 21, wherein the at least one finger includes a compliance portion having an S-shape.
